(19) United States
(12) Patent Application Publication
(10) Pub. No.: US 2012/0097302 A1
(43) Pub. Date: Apr. 26, 2012

(54) Tread with Antidegradant Reservoir

(76) Inventor: Peter D. Hetzel, Greer, SC (US)

(21) Appl. No.: 12/673,737

(22) PCT Filed: Aug. 31, 2007
(86) PCT No.: PCT/US07/77434

§ 371 Date: Feb. 16, 2010

(51) Int. Cl. B60C 1/00; B60C 11/00

(52) U.S. Cl. 152/209.5

(57) ABSTRACT

A tread band (16) and tire (10) having a tread band (16) bonded thereto, particular embodiments including a tread band (16) having an antidegradant reservoir (34) forming a part of the tread band (16) and having a rubber composition mixed with an antidegradant at a higher antidegradant concentration than an adjacent rubber composition (38) with the antidegradant reservoir (34) being in diffusive communication with the base surface (22) of a tread shoulder (36). The tread band (16) may further include a barrier layer (42) separating at least a portion of the antidegradant reservoir (34) from the adjacent rubber composition (38) Particular embodiments include a tread band (16) having an antidegradant reservoir (34) forming a part of the tread band (16), the antidegradant reservoir (34) comprising a rubber composition mixed with an antidegradant and a barrier layer (42) bordering at least a portion of the antidegradant reservoir, wherein the barrier layer (42) inhibits diffusion of the antidegradant from the antidegradant reservoir (34) through the barrier layer (42).

### BACKGROUND OF THE INVENTION

1. Field of the Invention

This invention relates generally to tires and more specifically, to tire tread bands manufactured from rubber compositions having antidegradants.

2. Description of the Related Art

When tires become worn, they can be restored with new tread. Large truck tires and bus tires, for example, are typically retreaded as part of a routine tire-management program. The carcass of a these types of tires is expected to last several hundred thousand miles and be amenable to having a new tread adhered to it several times. Such tires are quite expensive and are therefore bought with the expectation that their high initial costs are offset by the long service life of the carcass and the low comparative cost of retreading. Indeed, the economics included in the selection and purchase of such tires often dictate that the original tires be capable of being retreaded as many as three or four times.

A variety of procedures and different types of equipment are available for use in recapping or retreading pneumatic tires. One of the first steps in retreading a worn tire is to remove remaining tread material from the tire carcass, for example, by a procedure known as buffing. Next a layer of green (uncured) rubber, known as “cushion gum,” may be applied to the carcass. This layer of extruded uncured rubber may be stitched or adhesively bonded to the carcass. Next, a tread band is applied atop the layer of cushion gum. In the cold recapping process, the tread is cured rubber, and has a tread pattern already impressed in its outer surface. The tire is then placed in an autoclave, and heated under pressure for an appropriate time to induce curing of the gum layer, and bonding of the gum layer to the tread and the carcass. In the hot recapping process, the tread is uncured rubber, and has no tread pattern. The tire is then placed in a tire mold and heated under pressure for an appropriate time to cure the gum layer and the tread, and to cause the gum layer to bind with the tread and the carcass. The term “cure” refers to the formation of cross-links between the elastomer molecules in the rubber compound, otherwise known as vulcanization.

Typically tires that are meant to be retreaded multiple times have sidewalls, shoulders and crowns that have a decreasing level of ageing resistance over time. That is because over time, the antidegradants that are added to the new tires are depleted. The use of antidegradants to protect vulcanized rubber, for example, from cracking, fatigue, stress, heat, oxygen, ozone and other sources of deterioration are well known in the industry.

### SUMMARY OF THE INVENTION

The present invention provides articles having antidegradant reservoirs. In particular embodiments, the present invention includes a tread band for bonding to a tire carcass during a tire retreading process. The tread band includes a tread surface for providing traction and a base surface opposite to the tread surface. The base surface of a tread band is typically bonded to a tire carcass. Tread shoulders are formed on opposite sides of the tread band and they bound the band central portion.

An antidegradant reservoir forms a part of the tread band, the antidegradant reservoir comprising a rubber composition mixed with an antidegradant at a higher antidegradant concentration than an adjacent rubber composition of the tread band. Furthermore, the antidegradant reservoir is in diffusive communication with the base surface of at least one of the tread shoulders.

Particular embodiments of the present invention further include a barrier layer separating at least a portion of the antidegradant reservoir from the adjacent rubber composition. The barrier layer inhibits diffusion of the antidegradant from the antidegradant reservoir to the adjacent rubber composition. In particular embodiments, the barrier layer directs the diffusion of the antidegradant from the antidegradant reservoir, through the base under the tread shoulders and into the shoulders of the tire carcass.

Additional embodiments of the present invention include tread bands having an antidegradant reservoir forming a part of the tread band, the antidegradant reservoir comprising a rubber composition mixed with an antidegradant and a barrier layer bordering at least a portion of the antidegradant reservoir, wherein the barrier layer inhibits diffusion of the antidegradant from the antidegradant reservoir through the barrier layer.

Particular embodiments of the present invention further include tires having a tire carcass with a crown portion and a tread band bonded to the crown portion of the tire, the tread band having the characteristics as described above.

The foregoing and other objects, features and advantages of the invention will be apparent from the following more detailed descriptions of particular embodiments of the invention, as illustrated in the accompanying drawing wherein like reference numbers represent like parts of the invention.

### BRIEF DESCRIPTION OF THE DRAWINGS

FIG. 1 is a partial cross-sectional partially exploded view of a retread tire having antidegradant reservoirs formed in the tread band in accordance with one exemplary embodiment of the invention.

FIGS. 2-5 are partial cross-section views of tread bands that can replace the tread band on the retread tire shown in FIG. 1.

### DETAILED DESCRIPTION OF PARTICULAR EMBODIMENTS

Particular embodiments of the present invention include articles having antidegradant reservoirs and methods for using and making these articles. Particular embodiments include articles comprising rubber materials with antidegradant reservoirs, e.g., areas having a high concentration of antidegradants. Particular embodiments include articles that are tread bands having antidegradant reservoirs and tires having such tread bands.

In particular embodiments such as tread bands having antidegradant reservoirs, the antidegradants can diffuse from the antidegradant reservoirs, through the base of a tread band and then into the tire carcass to which the tread band is bonded. Such diffusion of the antidegradants may be especially beneficial in retreaded tires because the antidegradants can diffuse from the reservoirs of the tread band to the retreaded tire carcass, thereby replacing at least a portion of the depleted antidegradant of the tire carcass.

Particular embodiments of the present invention may further include articles having barrier layers that direct the diffusion of the antidegradants from the antidegradant reservoir to selected or desired locations. For example, particular embodiments include a tire tread band having a barrier layer that directs the diffusion of the antidegradants from the antidegradant reservoir in the tread band to the tire carcass or to selected parts of the tire carcass. In particular embodiments, the antidegradants are directed towards the shoulder area of the tire carcass. The shoulder area of the tire carcass is near the upper portion of the tire sidewall and includes the area below which the shoulder area of the tread band is bonded to the tire carcass. Having additional antidegradant in the shoulder area of the tire carcass can be beneficial and may provide additional protection to that area of the tire carcass. The antidegradants may be directed to one or more areas of the carcass from the tread band or, as regarding embodiments that are not related to tires, from the antidegradant reservoirs to one or more areas of other articles as desired for particular applications.

Antidegradants that are located in the antidegradant reservoirs of the tread band will diffuse from the antidegradant reservoirs unless inhibited, blocked or diverted by a barrier that reduces or stops diffusion through the barrier. Diffusion is the phenomenon of random motion of molecules that causes a system to decay towards uniform conditions by causing a net movement of molecules from an area of higher concentration to an area of lower concentration until equilibrium is reached. Therefore, in a given system, molecules will generally diffuse from an area of high concentration to an area of low concentration until the concentration gradient approaches zero.

Diffusive communication, as used herein, is defined as having a pathway for molecules to diffuse freely from an area of high concentration to an area of low concentration. Therefore, an antidegradant reservoir is in diffusive communication with another area when the antidegradant is capable of freely diffusing over a pathway between the antidegradant reservoir and the other area. Molecules diffuse freely when not blocked or impeded by a barrier material.

Particular embodiments of the present invention therefore may further provide barrier layers that direct the diffusion of the antidegradants from the antidegradant reservoirs to preferred areas of the article, such as a tire carcass. By proper placement of inhibiting barrier layers that impede or block diffusion of the antidegradants through the barrier layer, the diffusive path of the antidegradants can be diverted or directed to preferred areas, thereby causing the antidegradants, for example, to diffuse to preferred areas of the tire carcass. In particular embodiments, the barrier layer surrounds or bounds at least a portion of the antidegradant reservoir. The barrier layer blocks diffusive communication by blocking the diffusion path completely or by at least significantly reducing the diffusion rate across the barrier layer.

To impede or limit the diffusion of antidegradants through the barrier layer, the barrier layer is made of materials that have reduced solubility and/or reduced mobility of the antidegradants through the material when compared with the solubility and/or mobility of the antidegradant through the surrounding materials. Examples of materials that may be used as barrier layers include elastomers such as butyl rubber, EPDM, formulations having high crosslinked density (e.g., high sulfur and accelerator loadings) or combinations thereof. Generally, those materials that are useful to inhibit diffusion of air through an inflated article are useful materials for barrier layers. In particular embodiments of the invention, these materials may be mixed with other elastomers having preferred properties for the tire tread band such as, for example, natural rubber, SBR or polybutadiene. Similarly, these materials may be mixed with other elastomers having preferred properties of whatever the article is that includes antidegradant reservoirs.

The thickness of the barrier layer is not limited by the invention and may be only a thin layer surrounding at least a portion of the antidegradant reservoir or it may be significantly thicker. Particular embodiments may include a barrier layer having a thickness, for example, of between 0.1 and 1 mm, between 0 .5 mm to 3 mm or between 1 mm and 10 mm as desired for particular applications.

The antidegradant reservoirs comprise an antidegradant and other materials that are used in the tread band or other article. The total mixture of elastomers and other materials is known as the rubber composition. The materials that may appear in a rubber composition for a given embodiment might be, for example, one or more elastomers, carbon black, silica, clay, resin, oils, sulfur, vulcanizing accelerators and/or other materials known to those having ordinary skill in the art. Particular embodiments of the present invention may include antidegradant reservoirs that are made of the same rubber composition as one or more rubber compositions contained within the article, such as a tread band, except that the antidegradant reservoir may have a higher concentration of the one or more antidegradants.

The use of antidegradants to protect vulcanized rubber from cracking, fatigue, stress, heat, oxygen, ozone and other sources of deterioration are well known in the industry. Many antidegradants are known, for example, as antioxidants, antiozonants and/or anti-fatigue though other antidegradants are also known and are useful in particular embodiments of the present invention.

Examples of known antidegradants include para-phenylene diamines (PPDA) examples of which include: N-isopropyl-N′-phenyl-p-phenylene diamine (IPPD), N-(1,3-dimethylbutyl)-N′-phenyl-p-phenylene diamine (6PPD), N,N′-di(1,4-dimethylpentyl)-p-phenylene diamine (77PD), a mixture of N,N′-diaryl-p-phenylene diamines (DTPD) and diaryl-p-phenylenediamine (DAPD). Other examples of antidegradants include 4- and 5-methyl-2-mercapto-benzimidazole (MMBI), zinc salt of 4- and 5-methyl-2-mercapto-benzimidazole (ZMMBI), octylated diphenylamine (ODPA), 2,2,4-trimethyl-1,2-dihydroquinoline, polymerized (TMQ) and 2,2′-methylene-bis-(4-methyl-6-tert.-butylphenol) (BPH).

The antidegradant reservoirs may contain one or several antidegradants. The antidegradants that may be contained within the reservoirs is not limited by the invention. Any or all antidegradants that are useful for a particular application may be included in the antidegradant reservoirs of particular embodiments of the invention.

The concentration of each antidegradant in the reservoir may vary for each antidegradant and is not limited by the invention. However, for particular embodiments of the invention, the loading of the antidegradant may be about 4 times the supplier recommended loading for the particular antidegradant. Other embodiments may include a loading of between 2 and four times or between 2 and 3 times the supplier recommended loading. Other embodiments may include a loading of between 1 and 3 times the supplier recommended loading. For example, while not limiting the invention, particular embodiments may include a 6 PPD loading of between 3 and 6 parts per hundred rubber (phr), a 77PD loading of between 1 and 6 phr and/or a TMQ loading of between 1.5 and 6 phr. Of course in particular embodiments, higher or lower concentrations of these materials may be added to the antidegradant reservoirs.

The articles of the present invention that have antidegradant reservoirs may be formed with processes well known to those having ordinary skill in the art. A full disclosure of such known processes is neither required nor proper. However, it is noted that the articles of particular embodiments of the present invention, including tread bands having antidegradant reservoirs either with or without barrier layers, may be formed through a coextrusion process.

In the coextrusion process, two or more materials are extruded through a single die with two or more orifices arranged so that the extrudates merge and weld together into a laminar structure. Coextrusion machines are manufactured by companies that include, for example, Harburg-Freudenberger, Troester, Ltd. and Berstorff. The coextrusion process allows the lamination of two or more compounds under pressure. This lamination occurs before the compounds exit the tooling. The tooling defines the product geometry and consists of a preform and die. The preform directs the compound flow inside the die, while the die controls the overall profile geometry. Parameters on the extruder are controlled to ensure the extrudates respect both the geometry and rheological specifications of the product.

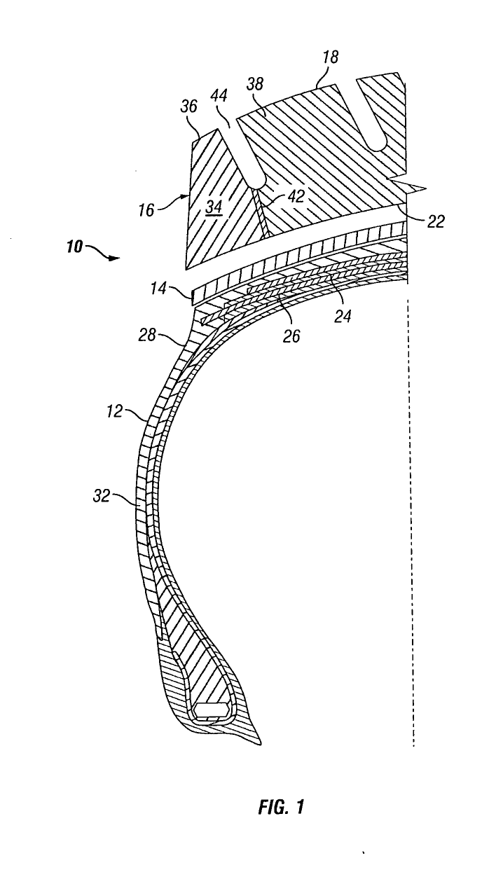

FIG. 1 is a partial cross-sectional partially exploded view of a retread tire having antidegradant reservoirs formed in the tread band in accordance with one exemplary embodiment of the invention. The retread tire 10 is shown comprising a tire carcass 12 having a crown 24, a reinforcement package 26 and a shoulder area 28 near the top of the sidewall 32 and extending generally towards the ends of the reinforcement package 26. The retread tire further includes a cushion gum layer 14 and a tread band 16.

The tread band 16 includes a tread surface 18 that contacts the road and provides traction. Tread grooves 44 or other features may be included as part of the tread band 16. The tread band 16 further includes a sole or base surface 22 that is opposite the tread surface 18. The base surface is bonded to the crown portion 24 of the tire carcass 12 by the cushion gum layer 14. The tread band further includes tread shoulders 36 that form opposing sides of the tread band 16 and that bound the central portion 38 of the tread band 16. The tread shoulders 36 are bonded to the tire carcass 12 generally above the shoulders 28 of the tire carcass 12.

Also included as part of the tread band 16 is an antidegradant reservoir 34 that is formed in this exemplary embodiment as the shoulder 36 of the tire band 16. The antidegradant reservoir 34 comprises a rubber composition mixed with an antidegradant at a concentration that is higher than the antidegradant concentration in the central portion 38 of the tire band 16. Since a lower concentration of antidegradant in the retread tire 10 is in the shoulder 28 of the tire carcass 12, the antidegradant will diffuse from the high concentration of antidegradant in the reservoir 34 to the low concentration of antidegradant in the shoulder 28 of the tire carcass 12.

In particular embodiments of the present invention, a barrier layer 42 may be included to direct the diffusion of antidegradants from the antidegradant reservoir 34 to a preferred area of the tire carcass 16. In the exemplary embodiment shown in FIG. 1, the barrier layer 42 inhibits the diffusion of antidegradant from the antidegradant reservoir 34 to the central portion of the tread band 38.

The cushion gum layer 14 is positioned between the ready-to-retread tire carcass 12 and the tread band 16. Once these elements are assembled under normal retread procedures, the tire 10 is then typically placed in an autoclave, and heated under pressure for an appropriate time to induce curing of the cushion gum layer 14, thereby bonding the tread band 16 to the tire carcass 12. It is noted that, in the examples described herein, a cushion gum layer 14 is used between the carcass 12 and the tread band 16. This is for example only and is not intended to be limiting on the invention. It is contemplated that any type of bonding interface can be used between the tread band 16 and the tire carcass 12; e.g., adhesives.

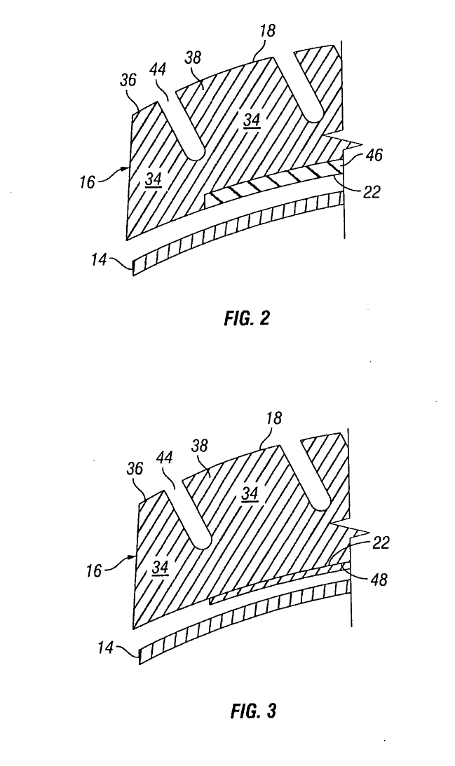

FIGS. 2-5 are partial cross-section views of tread bands that can replace the tread band 16 on the retread tire 10 shown in FIG. 1. FIG. 2 illustrates a tread band 16 having the tread shoulders 36 and the tread band central portion 38 as an antidegradant reservoir 34. A barrier layer 46 is provided above the base surface 22 of the central portion 38 of the tire band 16. The barrier layer 46 provides a block against the diffusion of antidegradant from the reservoir 34 to the crown portion 24 of the retread tire 10 except for that area of the shoulder 28 of the tire carcass 12. Therefore, the antidegradant may diffuse more easily from the antidegradant reservoir 34 to the shoulders 28 of the retread tire carcass 12.

FIG. 3 illustrates a tread band 16 similar to that shown in FIG. 2 except that the barrier layer 48 is applied to the base surface 22 of the central portion 38 of the tread band 16. Such application may be by brushing on an adhesive or other material having diffusive barrier properties or it may be, for example, extruded onto the surface. Similarly to the barrier layer 46 shown in FIG. 2, the antidegradant may diffuse more easily from the antidegradant reservoir 34 to the shoulders 28 of the retread tire carcass 12 but not to the central portion of the crown as diffusion is inhibited by the barrier layer 48.

FIG. 4 illustrates a tread band 16 having an antidegradant reservoir 34 extending through much of the tread band 16. In the exemplary embodiment shown in FIG. 4, the antidegradant reservoir 34 is open to the base surface 22 of the tread shoulder 36. Optionally, the portion of the tread band 16 between the base surface 22 and the reservoir 34 may be a barrier layer 56.

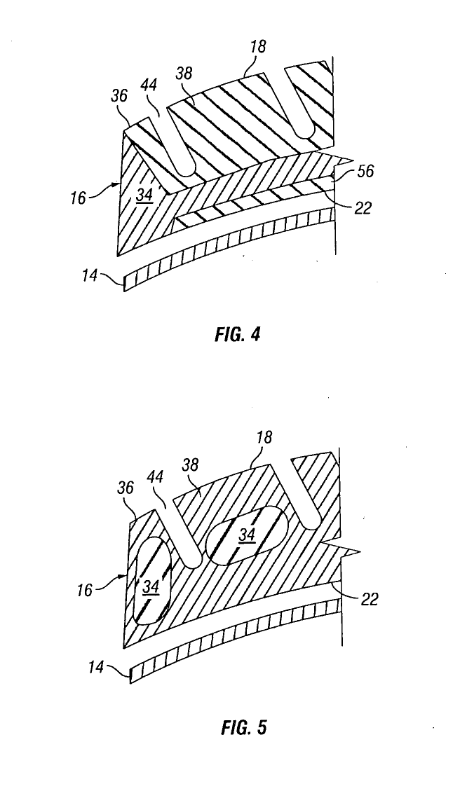

FIG. 5 illustrates a tread band having two antidegradant reservoirs 34 disposed in the tread band 16. Optionally, although not shown, one or more sides of the antidegradant reservoirs 34 may be bounded by a barrier layer.

The terms “comprising,” “including,” and “having,” as used in the claims and specification herein, shall be considered as indicating an open group that may include other elements not specified. The term “consisting essentially of,” as used in the claims and specification herein, shall be considered as indicating a partially open group that may include other elements not specified, so long as those other elements do not materially alter the basic and novel characteristics of the claimed invention. The terms “a,” “an,” and the singular forms of words shall be taken to include the plural form of the same words, such that the terms mean that one or more of something is provided. The terms “at least one” and “one or more” are used interchangeably. The term “one” or “single” shall be used to indicate that one and only one of something is intended. Similarly, other specific integer values, such as “two,” are used when a specific number of things is intended. The terms “preferably,” “preferred,” “prefer,” “optionally,” “may,” and similar terms are used to indicate that an item, condition or step being referred to is an optional (not required) feature of the invention. Ranges that are described as being “between a and b” are inclusive of the values for “a” and “b.”

It should be understood from the foregoing description that various modifications and changes may be made to the embodiments of the present invention without departing from its true spirit. The foregoing description is provided for the purpose of illustration only and should not be construed in a limiting sense. Only the language of the following claims should limit the scope of this invention.

What is claimed is:

1. A tread band for bonding to a tire carcass, the tread band comprising:
a tread surface for providing traction;
a base surface opposite the tread surface;
tread shoulders forming opposing sides of the tread band, the tread shoulders bounding a central portion of the tread band; and
an antidegradant reservoir forming a part of the tread band, the antidegradant reservoir comprising a rubber composition mixed with an antidegradant at a higher antidegradant concentration than an adjacent rubber composition of the tread band, the antidegradant reservoir being in diffusive communication with the base surface of at least one of the tread shoulders.

2. The tread band of claim 1, wherein the antidegradant reservoir is embedded within the tread band.

3. The tread band of claim 1, wherein the antidegradant reservoir comprises a tread rib formed in the tread shoulder.

4. The tread band of claim 1, wherein the antidegradant is an antioxidant, an antiozonant or combinations thereof.

5. The tread band of claim 1, further comprising:
a barrier layer separating at least a portion of the antidegradant reservoir from the adjacent rubber composition, wherein the barrier layer inhibits diffusion of the antidegradant from the antidegradant reservoir to the adjacent rubber composition.

6. The tread band of claim 5, wherein the barrier layer comprises butyl rubber, EPDM or combinations thereof.

7. The tread band of claim 1, further comprising:
a barrier layer forming at least a portion of the base surface of the tread band, wherein the barrier layer limits diffusion of the antidegradant through the barrier layer.

8. The tread band of claim 7, wherein the barrier layer includes the base surface of the central portion of the tread band, wherein the barrier layer limits diffusion of the antidegradant from the central portion of the tread band through the base surface of the central portion of the tread band.

9. A tread band for bonding to a tire carcass, the tread band comprising:
a tread surface for providing traction;
a base surface opposite the tread surface;
tread shoulders forming opposing sides of the tread band, the tread shoulders bounding a central portion of the tread band;
an antidegradant reservoir forming a part of the tread band, the antidegradant reservoir comprising a rubber composition mixed with an antidegradant; and
a barrier layer bordering at least a portion of the antidegradant reservoir, wherein the barrier layer inhibits diffusion of the antidegradant from the antidegradant reservoir through the barrier layer.

10. The tread band of claim 9, wherein the antidegradant reservoir is embedded within the tread band.

11. The tread band of claim 9, wherein the antidegradant reservoir comprises a tread rib formed in the tread shoulder.

12. The tread band of claim 9, wherein the antidegradant is an antioxidant, an antiozonant or combinations thereof.

13. The tread band of claim 9, wherein the barrier layer includes at least a portion of the base surface of the tread band, wherein the barrier layer limits diffusion of the antidegradant through the barrier layer.

14. The tread band of claim 13, wherein the barrier layer includes the base surface of the central portion of the tread band, wherein the barrier layer limits diffusion of the antidegradant from the central portion of the tread band through the base surface of the central portion of the tread band.

15. A tire, comprising:
a tire carcass having a crown portion;
a tread band bonded to the crown portion of the tire carcass, wherein the tread band comprises:
a tread surface for providing traction;
a base surface opposite the tread surface;
tread shoulders forming opposing sides of the tread band, the tread shoulders bounding a central portion of the tread band; and
an antidegradant reservoir forming a part of the tread band, the antidegradant reservoir comprising a rubber composition mixed with an antidegradant at a higher antidegradant concentration than an adjacent rubber composition of the tread band, the antidegradant reservoir being in diffusive communication with the base surface of at least one of the tread shoulders.

16. The tire of claim 15, wherein the tread band further comprises:
a barrier layer separating at least a portion of the antidegradant reservoir from the adjacent rubber composition, wherein the barrier layer limits diffusion of the antidegradant from the antidegradant reservoir to the adjacent rubber composition.

17. A tire, comprising:
a tire carcass having a crown portion;
a tread band bonded to the crown portion of the tire carcass, wherein the tread band comprises:
a tread surface for providing traction;
a base surface opposite the tread surface;
tread shoulders forming opposing sides of the tread band, the tread shoulders bounding a central portion of the tread band;
an antidegradant reservoir forming a part of the tread band, the antidegradant reservoir comprising a rubber composition mixed with an antidegradant; and
a barrier layer bordering at least a portion of the antidegradant reservoir, wherein the barrier layer limits diffusion of the antidegradant from the antidegradant reservoir through the barrier layer.

18. The tire of claim 17, wherein the barrier layer forms at least a portion of the base surface of the tread band, wherein the barrier layer limits diffusion of the antidegradant through the barrier layer.
